(19) United States
(12) Patent Application Publication
(10) Pub. No.: US 2009/0209139 A1
(43) Pub. Date: Aug. 20, 2009

(54) ELECTRIC CONNECTOR

(76) Inventor: Tien-Tzu HO, Taipei City (TW)

Correspondence Address: Muncy, Geissler, Olds & Lowe, PLLC, P.O. BOX 1364, FAIRFAX, VA, 22038-1364, US

(21) Appl. No.: 12/360,270

(22) Filed: Jan. 27, 2009

(30) Foreign Application Priority Data
Feb. 15, 2008 (TW) 97105455

(51) Int. Cl. H01R 24/00; H01R 13/46

(52) U.S. Cl. 439/676; 439/893

(57) ABSTRACT

An electric connector includes a connector body, to which a terminal pin holder, an electric conduction module, and a circuit board are assembled. A plurality of elastic electric terminal pins is mounted on the terminal pin holder, and each of the electric terminal pins includes a protruded arch section adapted to elastically press against one corresponding first contact provided on the circuit board. The electric conduction module includes a plurality of elastic conducting members, each of which has a sideward bent extension adapted to elastically press against on one corresponding second contact provided on the circuit board. Therefore, the electric connector can be manufactured with simplified process at reduced cost without the need of welding the electric terminal pins to the circuit board, and upgraded signal transmission quality can be obtained with the electric connector.

### FIELD OF THE INVENTION

The present invention relates to an electric connector, and more particularly to an improved electric connector that can be manufactured with simplified process at reduced cost while provides upgraded signal transmission quality.

### BACKGROUND OF THE INVENTION

Generally, an electronic device is equipped with electric connectors for signal transmission, so as to meet different demands for signal connection. For example, a personal computer is normally equipped with an electric connector that enables network signal transmission. By connecting a network cable to the electric connector, the personal computer can provide a user with the networking function.

FIGS. 1 and 2 are exploded and assembled perspective views, respectively, of a conventional electric connector 9 for signal transmission, and FIG. 3 is a sectioned side view of the conventional electric connector 9. As shown, the conventional electric connector 9 has a jack 95, via which an external signal line 93 is connected to the electric connector 9 for signal transmission. The signal line 93 can be a network cable, a telephone cord, etc. The electric connector 9 also has a plurality of elastic and electrically conductive terminal pins 91, which are connected to a circuit board 92.

As can be clearly seen from FIGS. 1 to 3, the elastic terminal pins 91 are usually connected to the circuit board 92 by welding. Therefore, welding nuggets 94 are formed on the circuit board 92 at the connecting positions. The welding increases and complicates the manufacturing process of the electric connector 9 to increase the manufacturing cost thereof. In addition, the welding nuggets 94 at the connecting positions of the elastic terminal pins 91 and the circuit board 92 are actual tin solder. Like dust and impurities, the tin solder will adversely affect the signal transmission quality. Thus, the structure of the conventional electric connector 9 is not ideal in terms of signal transmission quality.

### SUMMARY OF THE INVENTION

A primary object of the present invention is to provide an electric connector that can be manufactured with simplified process at reduced cost while provides upgraded signal transmission quality.

To achieve the above and other objects, the electric connector according to a preferred embodiment of the present invention includes a connector body, a terminal pin holder, an electric conduction module, and a circuit board.

The connector body defines a jack for an external signal line to insert thereinto. The terminal pin holder has a plurality of elastic electric terminal pins mounted thereon. Each of the electric terminal pins includes a connecting section and a protruded arch section. The electric conduction module includes a plurality of elastic conducting members, each of which has a sideward bent extension. The circuit board is formed with a plurality of first contacts corresponding to the arch sections of the electric terminal pins and a plurality of second contacts corresponding to the sideward bent extensions of the elastic electric members.

The terminal pin holder, the electric conduction module, and the circuit board are assembled to the connector body with the connecting sections of the electric terminal pins on the terminal pin holder visibly located in the jack, the arch sections of the electric terminal pins on the terminal pin holder separately elastically pressing against the first contacts on the circuit board, and the sideward bent extensions of the elastic conducting members on the electric conduction module separately elastically pressing against the second contacts on the circuit board.

Therefore, with the present invention, the electric terminal pins in the electric connector are elastically pressing against and accordingly electrically connected to the circuit board without the need of being welded to the circuit board. Therefore, the electric connector of the present invention can be manufactured with simplified process at reduced cost while providing upgraded signal transmission quality.

According to another preferred embodiment of the present invention, the electric connector includes a terminal pin holder and a circuit board. The terminal pin holder has a plurality of elastic electric terminal pins mounted thereon, and each of the electric terminal pins includes a protruded arch section. The circuit board is formed with a plurality of contacts corresponding to the arch sections of the electric terminal pins.

The circuit board is assembled to the terminal pin holder with the arch sections of the electric terminal pins on the terminal pin holder elastically pressing against the corresponding contacts on the circuit board.

Therefore, in this embodiment of the present invention, the electric terminal pins in the electric connector are also elastically pressing against and accordingly electrically connected to the circuit board without the need of welding to the circuit board, allowing the electric connector to be manufactured with simplified process at reduced cost while providing upgraded signal transmission quality.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional electric connector;

FIG. 2 is an assembled perspective view of the conventional electric connector of FIG. 1;

FIG. 3 is a sectioned side view of the conventional electric connector of FIG. 1;

FIG. 4 is an exploded perspective view of an electric connector according to a first preferred embodiment of the present invention;

FIG. 5 is an exploded perspective view of a terminal pin holder for the electric connector of FIG. 4 with a circuit board separated therefrom;

FIG. 6 is a sectional view taken along line A-A of FIG. 4;

FIG. 7 is a sectional view taken along line B-B of FIG. 4;

FIG. 8 is an exploded perspective view of an electric conduction module for the electric connector of FIG. 4;

FIG. 9 is an assembled perspective of FIG. 4;

FIG. 10 is an exploded perspective view of an electric connector according to a second preferred embodiment of the present invention;

FIG. 11 is an exploded perspective view of a terminal pin holder for the electric connector of FIG. 10 with a circuit board separated therefrom;

FIG. 12 is an assembled sectional view of FIG. 11;

FIG. 13 is an exploded perspective view of an electric conduction module for the electric connector of FIG. 10;

FIG. 14 is an assembled perspective view of FIG. 10;

FIG. 15 is an exploded perspective view of an electric connector according to a third preferred embodiment of the present invention; and

FIG. 16 is an exploded perspective view of an electric connector according to a fourth preferred embodiment of the present invention.

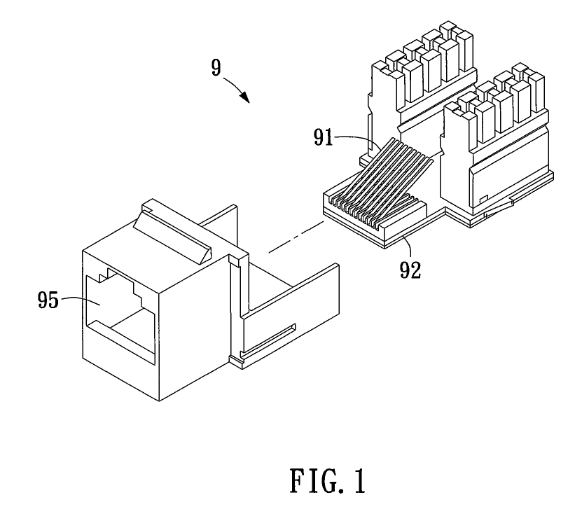

### DETAILED DESCRIPTION OF THE PREFERRED EMBODIMENTS

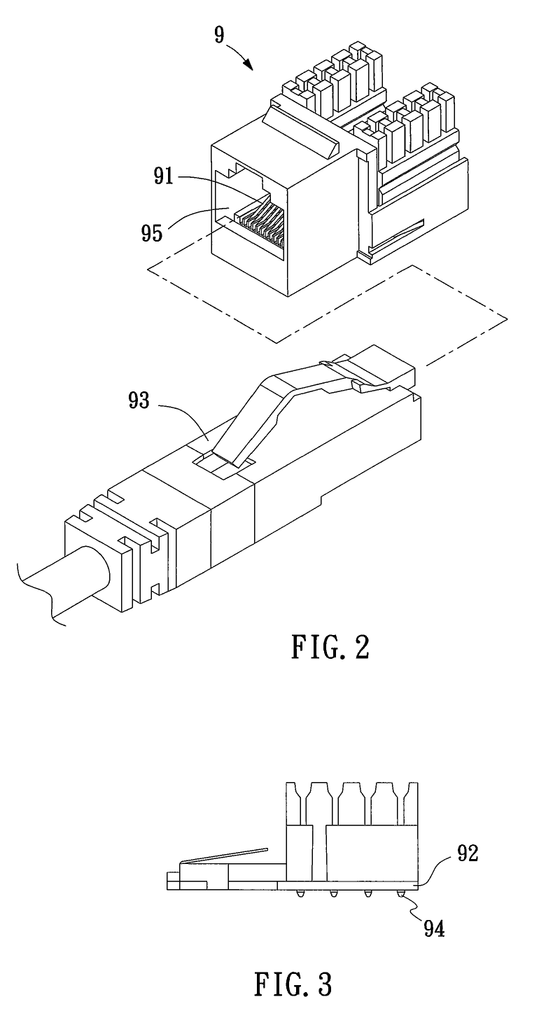

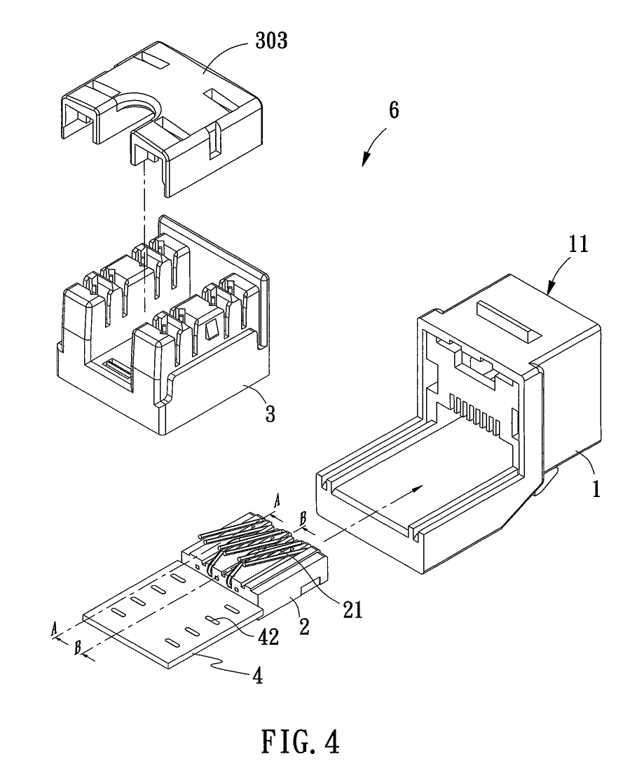

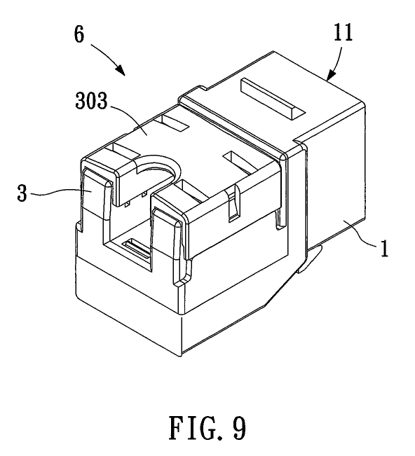

Please refer to FIGS. 4 and 9, which are exploded and assembled perspective views, respectively, of an electric connector 6 according to a first preferred embodiment of the present invention. As shown, the electric connector 6 includes a connector body 1, a terminal pin holder 2, an electric conduction module 3, and a circuit board 4. The connector body 1 defines a jack 11, into which an external signal line (not shown in FIG. 4), such as a network cable, a telephone cord, etc., can be inserted to electrically connect to the electric connector 6. While the jack 11 is not visible in FIG. 4 due to a view angle thereof, the jack 11 is generally similar to the jack 95 shown in FIG. 2.

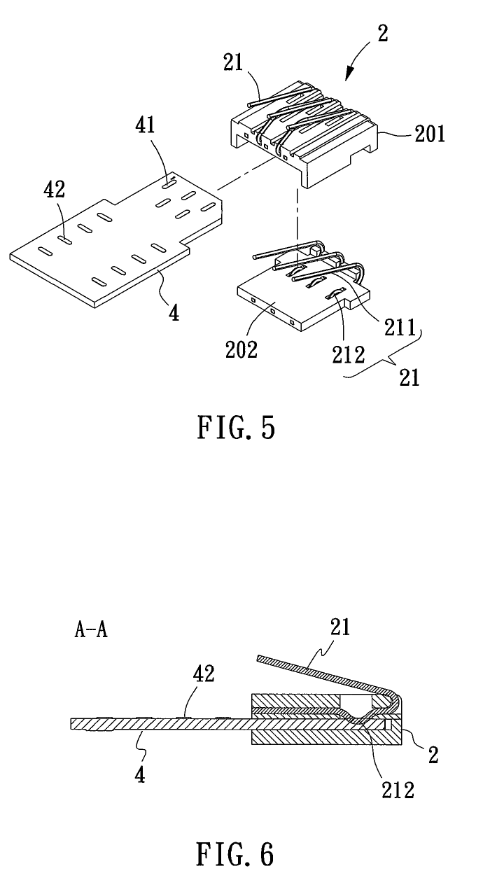

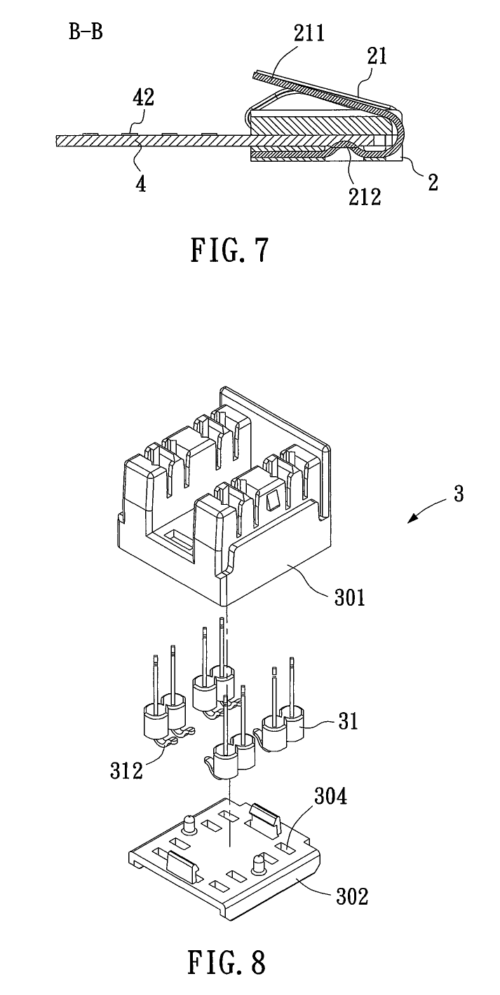

FIG. 5 is an exploded perspective view of the terminal pin holder 2 with the circuit board 4 separated therefrom, FIG. 6 is a sectional view taken along line A-A of FIG. 4, and FIG. 7 is a sectional view taken along line B-B of FIG. 4. Please refer to FIGS. 4 through 7. As shown, the terminal pin holder 2 has a plurality of elastic electric terminal pins 21 mounted thereon. Each of the electric terminal pins 2 has a straight connecting section 211 and a protruded arch section 212. In the illustrated first preferred embodiment, the terminal pin holder 2 is composed of a first terminal pin holder 201 and a second terminal pin holder 202, which are assembled together to form the complete terminal pin holder 2. The plurality of terminal pins 21 are separately mounted on the first and the second terminal pin holder 201, 202.

FIG. 8 is an exploded perspective view of the electric conduction module 3 for the electric connector 6 according to the first preferred embodiment of the present invention. As shown, the electric conduction module 3 includes a plurality of elastic conducting members 31 and a dust cover 303. Each of the elastic conducting members 31 has a sideward bent extension 312. The dust cover 303 is used to protect the elastic conducting members 31 against contamination by wet and dust, so that the signal transmission quality of the electric connector 6 is not adversely affected by external environment.

In the illustrated first preferred embodiment, the electric conduction module 3 also includes a main body 301 and a base 302, which are assembled to each other. The base 302 is formed with a plurality of through holes 304 corresponding to the sideward bent extensions 312 of the elastic conducting members 31.

As can be seen from FIGS. 5 and 8, the circuit board 4 is formed with a plurality of first contacts 41 corresponding to the protruded arch sections 212 of the electric terminal pins 21 on the terminal pin holder 2, and a plurality of second contacts 42 corresponding to the sideward bent extensions 312 of the elastic conducting members 31 on the electric conduction module 3.

Please refer to FIGS. 4 through 9 at the same time. The terminal pin holder 2, the electric conduction module 3, and the circuit board 4 are assembled to the connector body 1 with the connecting sections 211 of the electric terminal pins 21 on the terminal pin holder 2 correspondingly visibly located in the jack 11. Therefore, an external signal line (not shown) inserted into the jack 11 can be electrically connected to the connecting sections 211 of all the electric terminal pins 21 to enable signal transmission via the electric connector 6.

As having been described above, the first contacts 41 on the circuit board 4 are formed corresponding to the arch sections 212 of the electric terminal pins 21 on the terminal pin holder 2, and the second contacts 42 of the circuit board 4 are formed corresponding to the sideward bent extensions 312 of the elastic conducting members 31 on the electric conduction module 3. Therefore, when the terminal pin holder 2, the electric conduction module 3, and the circuit board 4 have been assembled to the connector body 1, all the arch sections 212 of the electric terminal pins 21 will elastically press against the corresponding first contacts 41 on the circuit board 4, and all the sideward bent extensions 312 of the elastic conducting members 31 will extend through the corresponding through holes 304 on the base 302 of the electric conduction module 3 to elastically press against the corresponding second contacts 42 on the circuit board 4.

That is, the arch sections 212 of the electric terminal pins 21 on the terminal pin holder 2 separately elastically press against the first contacts 41 on the circuit board 4, and the sideward bent extensions 312 of the elastic conducting members 31 on the electric conduction module 3 separately elastically press against the second contacts 42 on the circuit board 4. Therefore, the electric terminal pins 21 and the elastic conducting members 31 are elastically pressing against the circuit board 4 to achieve the electric connection between them and accordingly the purpose of signal transmission. In this manner, the disadvantages of the conventional electric connector 9 caused by welding the electric terminal pins 91 to the circuit board 92 can be eliminated. In other words, the electric connector of the present invention can be manufactured with simplified process at reduced cost while providing upgraded signal transmission quality.

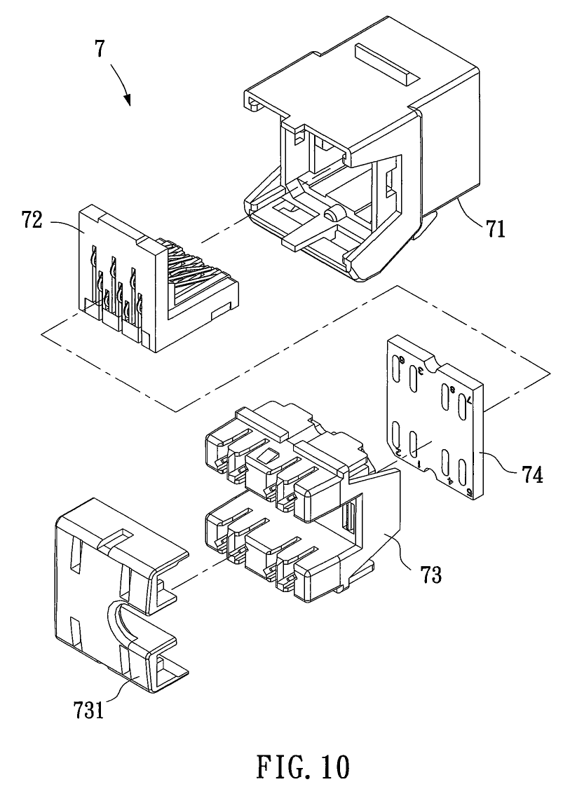

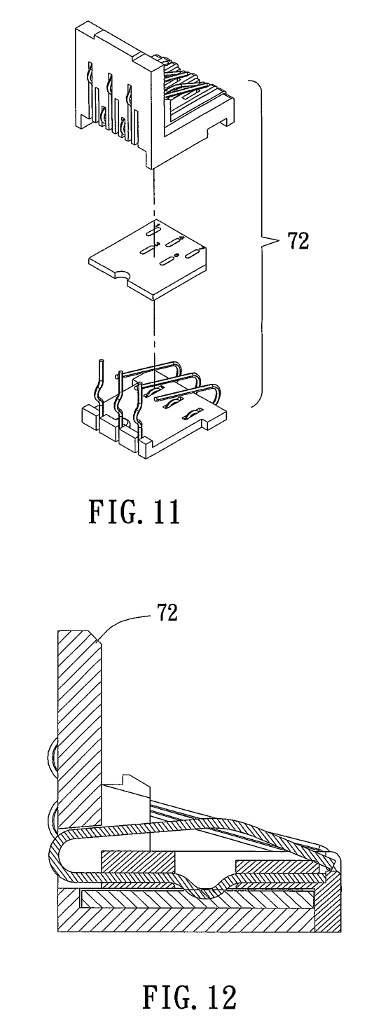

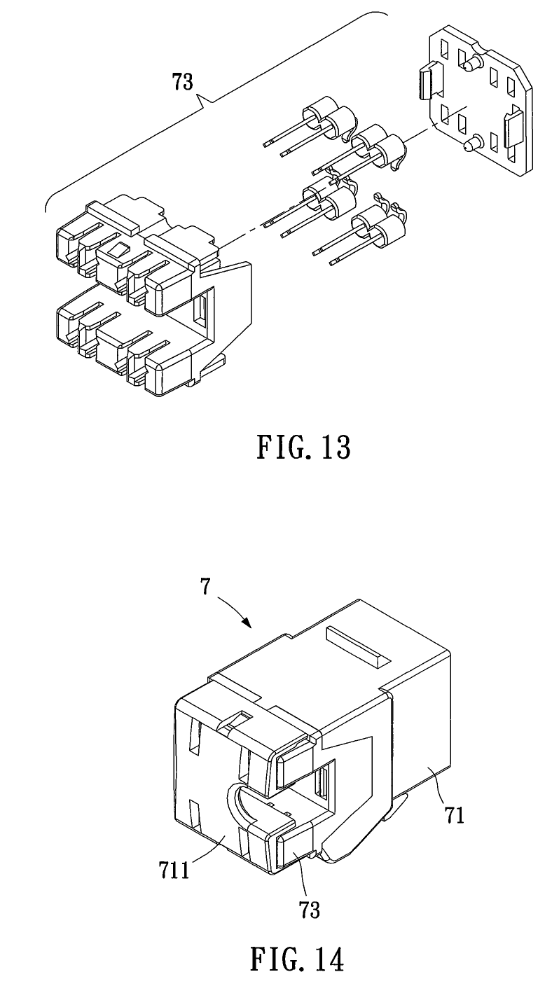

FIGS. 10 and 14 are exploded and assembled perspective views, respectively, of an electric connector 7 according to a second preferred embodiment of the present invention. As shown, the electric connector 7 has main structure similar to that of the electric connector 6 in the first preferred embodiment, and includes a connector body 71, a terminal pin holder 72, an electric conduction module 73 with a dust cover 731, and a circuit board 74. FIG. 11 is an exploded perspective view of the terminal pin holder 72, FIG. 12 is an assembled sectional view of the terminal pin holder 72, and FIG. 13 is an exploded perspective view of the electric conduction module 73. As can be seen from FIGS. 10 through 14, the electric connector 7 is different from the electric connector 6 in that the terminal pin holder 72 is a right-angled member instead of a horizontal member, and that the circuit board 74 and the electric conduction module 73 are turned by 90 degrees to assemble to a vertical back portion of the terminal pin holder 72 in a horizontal direction.

From the above description, it is understood the electric connector 6, 7 according to the first and the second preferred embodiment, respectively, of the present invention can be changed in design for the parts thereof to be assembled in different angular positions to satisfy different environmental factors, such as the size of space available for mounting the electric connectors 6, 7.

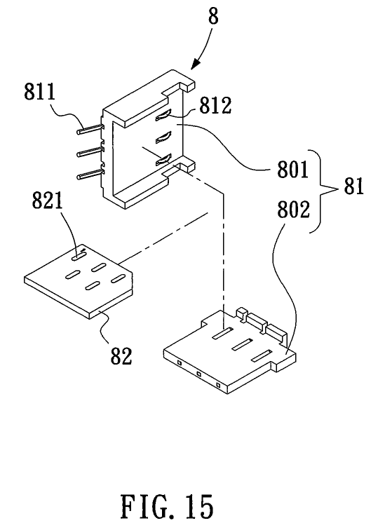

Please refer to FIG. 15 that is an exploded perspective view of an electric connector 8 according to a third preferred embodiment of the present invention. As shown, the electric connector 8 is structurally similar to the first and the second preferred embodiment, and has a terminal pin holder 81 and a circuit board 82. The terminal pin holder 81 has a plurality of elastic electric terminal pins 811 mounted thereon. Each of the electric terminal pins 811 has a protruded arch section 812. The circuit board 82 is formed with a plurality of contacts 821 corresponding to the arch sections 812 of the electric terminal pins 811.

The circuit board 82 is assembled to the terminal pin holder 81, such that all the arch sections 812 of the electric terminal pins 811 on the terminal pin holder 81 are elastically pressing against corresponding contacts 821 on the circuit board 82.

In the illustrated third preferred embodiment, the terminal pin holder 81 is composed of a first terminal pin holder 801 and a second terminal pin holder 802, which are assembled together with the circuit board 82 located between them.

Again, in the third preferred embodiment, the electric terminal pins 811 and the circuit board 82 are electrically connected to one another by elastically pressing the arch sections 812 against the contacts 821 to achieve the same effect as the previous embodiments.

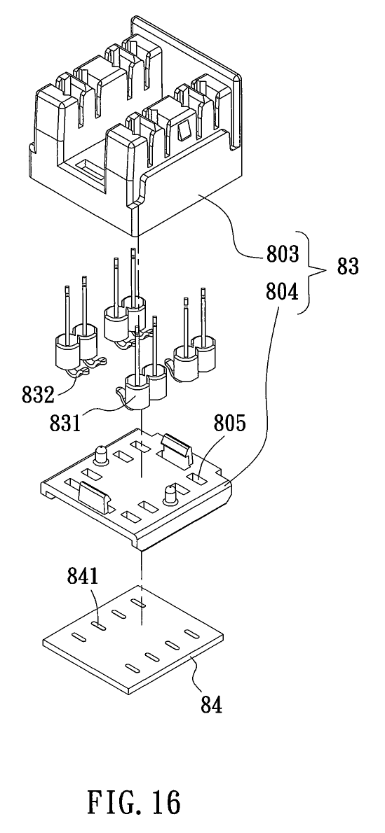

FIG. 16 is an exploded perspective view of an electric connector according to a fourth preferred embodiment of the present invention. As shown, the electric connector in the fourth embodiment is generally structurally similar to the third embodiment, and has a terminal pin holder 83 and a circuit board 84. The terminal pin holder 83 has a plurality of elastic electric terminal pins 831 mounted thereon. Each of the electric terminal pins 831 has an arch section 832. The circuit board 84 is provided with a plurality of contacts 841 corresponding to the arch sections 832 of the electric terminal pins 831.

The circuit board 84 is assembled to the terminal pin holder 83, such that the arch sections 832 of the electric terminal pins 831 on the terminal pin holder 83 are elastically pressing against corresponding contacts 841 on the circuit board 84.

In the illustrated fourth preferred embodiment, the terminal pin holder 83 is composed of a first terminal pin holder 803 and a second terminal pin holder 804, which are assembled together to form a complete terminal pin holder 83. The second terminal pin holder 804 is formed with a plurality of through holes 805 corresponding to the arch sections 832 of the electric terminal pins 831, such that the arch sections 832 of the electric terminal pins 831 can extend through the corresponding through holes 805 to elastically press against the corresponding contacts 841 on the circuit board 84.

Again, in the fourth preferred embodiment, the electric terminal pins 831 and the circuit board 84 are electrically connected to one another by elastically pressing the arch sections 832 against the contacts 841 to achieve the same effect as the previous embodiments.

With the above arrangements, the electric connector according to the present invention has electric terminal pins elastically pressing against and accordingly electrically connected to the circuit board thereof, and can therefore be manufactured with simplified process at reduced cost while providing upgraded signal transmission quality. Thus, the present invention is improved to effectively overcome the drawbacks of the conventional electric connector, and is more practical for use to meet consumers' demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An electric connector, comprising:
a connector body defining a jack for an external signal line to insert thereinto;
a terminal pin holder having a plurality of elastic electric terminal pins mounted thereon, and each of the electric terminal pins having a connecting section and a protruded arch section;
an electric conduction module including a plurality of elastic conducting members, and each of the elastic conducting members being provided with a sideward bent extension; and
a circuit board being formed with a plurality of first contacts corresponding to the arch sections of the electric terminal pins, and a plurality of second contacts corresponding to the sideward bent extensions of the elastic conducting members; and
wherein the terminal pin holder, the electric conduction module, and the circuit board are assembled to the connector body with the connecting sections of the electric terminal pins on the terminal pin holder visibly located in the jack, the arch sections of the electric terminal pins on the terminal pin holder separately elastically pressing against the first contacts on the circuit board, and the sideward bent extensions of the elastic conducting members on the electric conduction module separately elastically pressing against the second contacts on the circuit board.

2. The electric connector as claimed in claim 1, wherein the terminal pin holder is composed of a first terminal pin holder and a second terminal pin holder assembled to each other, and wherein the plurality of electric terminal pins are separately mounted on the first and the second terminal pin holder.

3. The electric connector as claimed in claim 1, wherein the electric conduction module includes a main body and a base assembled to each other.

4. The electric connector as claimed in claim 3, wherein the base of the electric conduction module is provided with a plurality of through holes corresponding to the sideward bent extensions of the elastic conducting members, and the sideward bent extensions being extended through the corresponding through holes to elastically press against the corresponding second contacts on the circuit board.

5. The electric connector as claimed in claim 1, wherein the electric conduction module further includes a dust cover.

6. An electric connector, comprising:
a terminal pin holder having a plurality of elastic electric terminal pins mounted thereon, and each of the electric terminal pins having a protruded arch section; and
a circuit board being formed with a plurality of contacts corresponding to the arch sections of the electric terminal pins; and
wherein the circuit board is assembled to the terminal pin holder with the arch sections of the electric terminal pins on the terminal pin holder separately elastically pressing against the corresponding contacts on the circuit board.

7. The electric connector as claimed in claim 6, wherein the terminal pin holder is composed of a first terminal pin holder and a second terminal pin holder assembled to each other.

8. The electric connector as claimed in claim 7, wherein the second terminal pin holder is formed with a plurality of through holes corresponding to the arch sections of the electric terminal pins, and the arch sections being extended through the corresponding through holes to elastically press against the corresponding contacts on the circuit board.
